(19) United States
(12) Patent Application Publication
(10) Pub. No.: US 2026/0268430 A1
(43) Pub. Date: Sep. 10, 2026

(54) Process for Creating and Distributing Library-Centric Open Educational Resources (OER)

(71) Applicant: Jennifer Leigh Goodland, FARMINGTON, NM (US)

(72) Inventor: Jennifer Leigh Goodland, FARMINGTON, NM (US)

(21) Appl. No.: 19/074,357

(22) Filed: Mar. 8, 2025

(51) Int. Cl. G06Q 50/20

(52) U.S. Cl. CPC G06Q 50/205

(57) ABSTRACT

This invention describes a modular, schema-driven process for creating and distributing educational resource packages using library-curated open access and licensed materials. Instructional needs are defined through collaboration between faculty and librarians, with course configuration data informing an AI-assisted schedule generation system. Depending on whether a textbook is retained, augmented, or replaced, content is sequenced accordingly. Librarians curate relevant resources, which are integrated into structured instructional units using AI-assisted summarization, outcome tagging, and metadata alignment. Outputs include learning objectives, reading lists, reflection prompts, explanatory narratives, vocabulary exercises, leveled readings, and standards-aligned worksheets.

Standards alignment is achieved through automated cross-referencing and human review. Final content is formatted for deployment across library platforms and learning management systems, ensuring compliance with accessibility and licensing protocols. Faculty review the curriculum prior to publication. Engagement data is analyzed post-deployment to inform iterative improvements, enabling scalable, affordable, and standards-compliant curriculum delivery.

### BACKGROUND

Educational institutions often struggle to provide affordable, standards-aligned learning materials customized for diverse grade levels. Current methods rely on expensive proprietary systems or time-intensive manual content curation. This invention provides an innovative and scalable process that integrates library-curated open-access materials with AI-driven adaptation, standards alignment, and seamless distribution via Learning Management Systems (LMS) and library platforms such as LibGuides. By automating key aspects of educational content customization and delivery, this invention enhances accessibility, affordability, and efficiency in course material development.

### SUMMARY OF INVENTION

This invention outlines a novel process for curating, adapting, packaging, and distributing educational materials derived from open-access and licensed library resources. The process is modular and may be implemented either manually or through partial or full automation. In certain embodiments, the process is structured using declarative schema logic to support scalable, standards-aligned curriculum generation. The key steps include:
Step 1: Determining Coursepack Needs—Faculty and librarians collaborate to assess instructional goals, existing course materials, and learner needs. Based on this review, the course design process incorporates a defined instructional content strategy, typically expressed in schema format as one of three options: “keep”, “augment”, or “replace” the primary textbook.
Step 2: Determining Instructional Structure—AI-assisted tools may be used to generate a structured course schedule based on faculty input, learning objectives, and declared instructional strategy. In certain embodiments, this may include machine learning models or other computational methods that assist in sequencing topics, aligning resources, or recommending instructional scaffolding formats.
Step 3: Identifying Library Resources—A librarian facilitates the selection of relevant educational resources to fulfill identified curriculum gaps. This may include curating open-access, licensed, or institutionally-hosted materials. In certain embodiments, the librarian uses AI-assisted filters, metadata-driven search tools, or schema-based topic maps to align content with instructional goals and declared outcomes.

Step 4: Integrating Library Materials—Curated resources are evaluated and processed for instructional use. In certain embodiments, AI assists in identifying the most relevant excerpts, summarizing key points, and categorizing resources based on topic, difficulty level, or pedagogical function (e.g., overview, case study, skills drill). The process may include automated or semi-automated extraction of learning-aligned content, generation of explanatory notes, or tagging for instructional mapping. The outputs from this step serve as inputs to subsequent curriculum development processes.

Step 5: Implementing Curriculum from Source Materials—Structured course content is generated from curated and processed resources. This includes generating formal instructional components such as unit-level learning outcomes, weekly reading schedules, reflection questions, and instructional narratives. In certain embodiments, this content is assembled using schema-based templates to ensure coherence and alignment with instructional goals. These core materials provide the primary framework for the course and may be reviewed or modified by educators prior to finalization.

Step 6: Producing Supplementary Instructional Materials—Instructional support materials are generated to enhance student engagement and scaffold learning based on the core curriculum. These may include vocabulary exercises, scaled or leveled reading passages, comprehension questions, or standards-aligned worksheets. In certain embodiments, these supports are automatically or semi-automatically generated using AI-assisted templates that draw from the established curriculum schema and content mappings, with customization based on student proficiency levels or accessibility needs.

Step 7: Standards Alignment and Compliance—Instructional materials are reviewed and aligned to relevant educational standards, including but not limited to Common Core, Advanced Placement (AP), International Baccalaureate (IB), state-specific standards, and institutional learning objectives. In certain embodiments, AI-assisted tools map curriculum elements to standards frameworks using metadata crosswalks or outcome-based tagging. Librarians or instructional designers may validate, edit, or supplement the AI-generated mappings to ensure pedagogical and accreditation compliance. A standards alignment document may be produced as part of the instructional output for reporting or quality assurance purposes.

Step 8: Formatting and Structuring for Delivery—AI optimizes instructional content for deployment on library-facing platforms and learning management systems. This may include structuring materials into modules or guide layouts, applying metadata tags, generating navigational elements, and validating resource links for copyright and licensing compliance.

Outputs may be adapted to support platform-specific formats and accessibility standards.

Step 9: Faculty Review and Publication—Faculty review the structured curriculum materials and may make adjustments prior to final deployment. This step ensures instructional accuracy, contextual alignment, and institutional fit before publication on designated platforms.

Step 10: Circulation Data Evaluation—Librarians assess engagement and usage metrics for deployed resources within learning management systems and library platforms. AI-assisted analytics may be used to compare pre- and post-deployment data, identify underused content, and inform future revisions of the curriculum package. This also may contribute to broader instructional strategy or resource allocation planning.

This process is designed to be modular and scalable, supporting partial or full automation and enabling adoption by educational institutions with minimal infrastructure or technical investment.

### BRIEF DESCRIPTION OF THE FIGURES

FIG. 1 illustrates the end-to-end workflow for creating, structuring, and distributing modular educational resource packages.

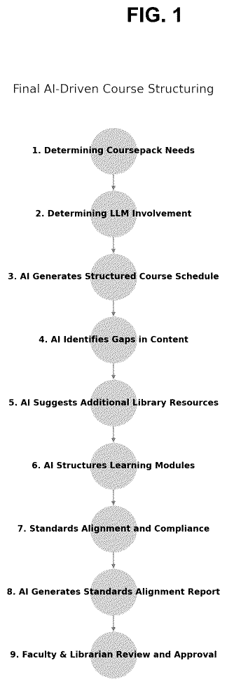

FIG. 2 details the AI-assisted instructional structuring system, including how learning objectives and instructional strategies inform the generation of course schedules.

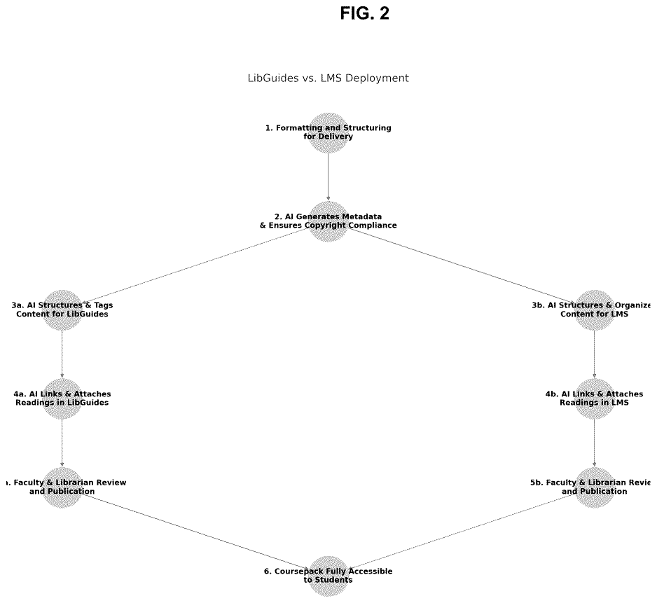

FIG. 3 presents the standards alignment and compliance process, demonstrating how instructional elements are mapped to accreditation and curricular frameworks.

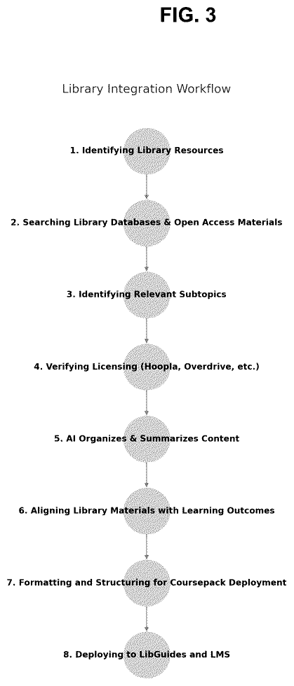

FIG. 4 describes the library resource integration workflow, outlining how curated materials are processed and aligned for instructional inclusion.

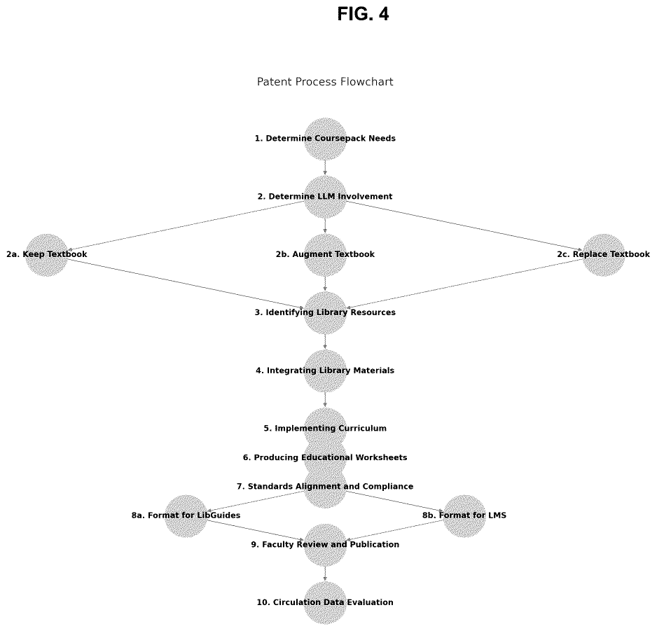

FIG. 5 compares deployment across library-facing and learning management platforms, highlighting structural and formatting differences in content delivery.

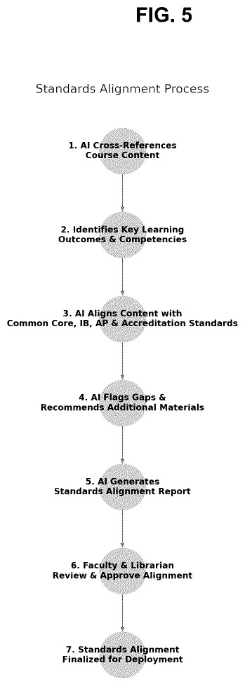

### DETAILED DESCRIPTION OF THE PROCESS

### Step 1: Determining Coursepack Needs. Actors Involved: Faculty and Librarian

Process: Faculty and librarians collaborate to assess the instructional context of the course. This includes reviewing the syllabus, identifying core learning outcomes, and evaluating any existing course materials, including textbooks, digital resources, and institutional requirements.

Output: A content strategy is selected and recorded as a structured field within the course configuration schema. The field textbook strategy is assigned one of three values: “keep”, “augment”, or “replace”, indicating the intended role of any existing textbook in the final course design.

Next Step: The selected strategy informs how AI-assisted tools structure the initial instructional schedule and identify content gaps during curriculum generation.

### Step 2: Determining Instructional Structure. Actors Involved: Librarian or System Administrator

Process: AI-assisted tools may be used to generate a structured course schedule based on faculty input, declared instructional strategy, and course configuration data, including the selected textbook strategy. In certain embodiments, the system uses schema-driven logic or rules-based engines to determine sequencing of topics, pacing, and recommended instructional content types.

Conditional Logic: If “keep” is selected, the system emphasizes alignment with the existing textbook structure. If “augment” is selected, the system identifies gaps between textbook coverage and intended learning outcomes. If “replace” is selected, the system generates a fully independent instructional sequence.

Output: A draft course schedule encoded in structured schema format (e.g., JSON, HTML, or XML) is produced for downstream processing and refinement.

### Step 3: Identifying Library Resources. Actors Involved: Librarian

Process: Based on the structured course schedule and instructional objectives, the system identifies educational resources to fulfill content needs. In certain embodiments, AI tools assist in matching subtopics to available materials using metadata analysis and standards mappings.

Actions: Subtopics are extracted from the draft schedule and aligned to subject taxonomies or curricular standards. AI-assisted search queries or filtering mechanisms surface relevant open-access, licensed, or institutionally-hosted resources. Licensing status, ebook availability, and access rights are validated during selection. Resources are provisionally assigned to modules or instructional blocks and may be reviewed, reprioritized, or annotated by the librarian.

### Step 4: Integrating Library Materials. Actors Involved: Librarian (With AI Assistance)

Process: Curated resources are evaluated and processed for instructional use. Structured schema fields are used to integrate these materials into unit-level components such as topic focus, instructional purpose, and outcome alignment. In certain embodiments, AI assists in identifying the most relevant excerpts, summarizing key points, and categorizing resources by topic, difficulty level, or pedagogical function (e.g., overview, case study, skills drill).

Actions: Each resource is assigned to a unit or module container within the structured course plan. AI may assist in tagging resources to outcome frameworks, academic standards, or metadata taxonomies. AI-generated summaries, excerpts, or contextual annotations may be included to support instructional integration, and may be reviewed or edited by librarians or faculty.

### Step 5: Implementing Curriculum from Source Materials. Actors Involved: AI, Librarian, and Faculty

Process: The system assembles structured instructional units based on curated content, standards alignments, and the defined course configuration. Course modules are generated using schema templates that organize content into pedagogically meaningful blocks.

Outputs: Unit-level learning outcomes, based on faculty goals or mapped standards; Reading lists composed of both library-curated and textbook-aligned content; Reflection questions or discussion prompts tied to unit themes; Short-form explanatory narratives or instructional context statements, which may be generated by AI and edited by librarians or faculty.

### Step 6: Producing Supplementary Instructional Materials. Actors Involved: AI tools and Librarian

Process: Instructional support materials are generated to enhance student engagement and scaffold learning based on the structured curriculum. These materials may be produced automatically or semi-automatically using adaptive content generation tools to support differentiated learning and varied proficiency levels.

Outputs may include: Vocabulary exercises based on unit terminology or learning goals; Scaled or leveled reading passages tailored to different reading proficiencies; Worksheets aligned to specific learning outcomes, standards, or instructional objectives. These materials may be reviewed, customized, or replaced by educators prior to deployment.

### Step 7: Standards Alignment and Compliance. Actors Involved: AI and Librarian

Process: Generated course materials, including core content and supplementary resources, are cross-referenced against relevant educational standards frameworks. This may include: Common Core; International Baccalaureate (IB), Advanced Placement (AP), and accreditation standards; State-specific and institution-defined learning objectives.

Output: A standards alignment report is generated to document how each unit, activity, or resource maps to specified benchmarks. In certain embodiments, alignment is achieved using metadata tagging, schema-based outcome fields, or AI-assisted comparison tools, with optional librarian validation prior to publication.

### Step 8: Formatting and Structuring for Delivery. Actors Involved: AI and Librarian

Process: Instructional content is formatted into structured, guide-style layouts suitable for library-hosted platforms. AI-assisted tools may generate: Linked readings with appropriate access paths or persistent identifiers; Introductory text blocks to contextualize unit content;

Metadata fields to enhance discovery and subject indexing within library systems. Formatting may follow platform-specific guidelines for accessibility and navigation.

Delivery for Learning Management Systems (LMS). Actors Involved: AI and Librarian.

Process: Instructional content is organized into platform-compatible instructional modules.

Actions: Content is arranged into nested modules and submodules based on instructional sequence. Links to external resources are structured to ensure licensing compliance and proper attribution. AI may suggest internal navigation, folder structure, or module titles optimized for usability and flow. Outputs may be exported in formats compatible with LMS import tools (e.g., HTML, IMSCC, SCORM) or other institutional platforms.

### Step 9: Faculty Review and Publication. Actors Involved: Faculty

Process: Faculty review the assembled curriculum across its intended delivery platforms, including learning management systems, library platforms, or other distribution environments. Edits or refinements may be made to ensure alignment with instructional goals, pedagogical tone, and course-specific context. Upon approval, the materials are finalized and published for student access.

### Step 10: Circulation Data Evaluation. Actors Involved: Librarian (With AI Assistance)

Process: Librarians assess engagement and usage metrics for deployed resources within learning management systems and library platforms. AI-assisted analytics may be used to evaluate the effectiveness of integrated materials by comparing pre- and post-implementation data.

Actions: AI analyzes usage metrics across platforms, including views, downloads, completion rates, and in-platform engagement. Insights from the analysis may be used to recommend content adjustments, identify underutilized resources, improve instructional sequencing, or inform broader instructional strategy and resource allocation planning.

1. A process for creating and distributing educational resource packages, comprising:
determining coursepack needs;
generating structured course schedules using AI;
curating and integrating library materials;
aligning content with educational standards; and
formatting and deploying content within LibGuides and LMS platforms.

2. The process of claim 1, wherein AI-driven adaptation dynamically adjusts text complexity and assessment difficulty.

3. The process of claim 1, wherein standards alignment includes automated verification and librarian oversight.

4. The process of claim 1, wherein AI suggests metadata tagging and structuring of educational content.

5. The process of claim 1, wherein engagement data is analyzed to refine and optimize future course materials.
